(19) United States
(12) Patent Application Publication
(10) Pub. No.: US 2026/0175481 A1
(43) Pub. Date: Jun. 25, 2026

(54) SYSTEM FOR FITTING TOGETHER TWO PIECES WHEREIN THE FITTING-TOGETHER SYSTEM COMPRISES TWO SLIDERS

(71) Applicant: ERMO, Marcille-La-Ville (FR)

(72) Inventors: Bertrand LASCOUP, Marcille-La-Ville (FR); Maurizio DEL NEVO, Marcille-La-Ville (FR)

(73) Assignee: ERMO, Marcille-La-Ville (FR)

(21) Appl. No.: 19/416,993

(22) Filed: Dec. 11, 2025

(30) Foreign Application Priority Data
Dec. 19, 2024 (FR) 2414659

(51) Int. Cl. B29C 45/00

(52) U.S. Cl. CPC B29C 45/006; B29C 2045/0063

(57) ABSTRACT

A system for fitting together two pieces including a chassis, for each end of a fitting-together bar, two linkages, wherein each has a distal end at which said end is mounted so as to be free to rotate, for the first two linkages, a first slider able to translate on the chassis, and wherein the proximal ends of said first two linkages are mounted so as to be free to rotate about a first axis, for the second two linkages, a second slider mounted so as to be able to translate on the chassis, and wherein the proximal ends of said second two linkages are mounted so as to be free to rotate, for each slider, an actuator for moving said slider, and a control unit arranged to control each actuator.

### TECHNICAL FIELD

The present invention relates to a system for fitting together two pieces, wherein the fitting-together system comprises a fitting-together bar the movement of which is controlled by two sliders mounted so as to be able to move in translation, as well as a moulding machine comprising such a fitting-together system.

### PRIOR ART

A closure of the type consisting of a closure for a bottle containing a liquid product such as shampoo, conditioner, washing-up product or the like generally comprises a body and a cap.

The body is intended to fit on a bottle and the cap is intended to be manoeuvred from a closed position to an open position and vice versa to enable the product to be held in the bottle or to flow out of the bottle.

Such caps can also be used in other sectors such as for example the automotive sector or the medical field.

The body and the cap are moulded together and are connected to each other by a hinge that makes it possible to move the cap with respect to the body.

FIG. 1 shows two closures 50, wherein each comprises a body 50a and a cap 50b hinged on the body 50a.

Conventionally, the body 50a and the cap 50b are moulded in a moulding machine between two jaws that have recesses and reliefs, and which come against each other to form cavities, where the body 50a and the cap 50b will be moulded.

FIG. 1 shows one of the jaws 60 on which the bodies 50a are held.

FIG. 1 also shows a fitting-together system 100 of the prior art that provides the tilting of each cap 50b and the fitting thereof on the associated body 50a.

The fitting-together system 100 comprises two parallel guide rails 102 and, for each guide rail 102, a carriage 104 able to move in translation on the guide rail 102.

For each carriage 104, the fitting-together system 100 comprises a first drive means 106, typically a motor with a ball screw, which provides the translational movement of the carriage 104 along the guide rail 102. The two carriages 104 face each other and move in a synchronised manner.

Each carriage 104 carries a crank 108, here in the form of a wheel, which is mounted so as to be able to rotate on the carriage 104 about a rotation axis 112. The axes of the cranks 108 of the two carriages 104 are coaxial and, for each carriage 104, the fitting-together system 100 comprises a second drive means 114, typically a motor, which provides the rotational movement of the crank 108 of the carriage 104.

The fitting-together system 100 also comprises a fitting-together bar 110 that is mounted between the two wheels 108 and offset with respect to the rotation axis 112.

The operation of the fitting-together system 100 is then as follows. After moulding, the closures 50 are offered up between the rails 102 and are still secured here to the jaw 60. The carriages 104 are moved in translation along the rails 102 so as to bring the fitting-together bar 110 under the caps 50b. The cranks 108 are rotated so as to cause the caps 50b to pivot under the action of the fitting-together bar 110 and, at the same time, the carriages 104 are moved in translation along the rails 102 so that the fitting-together bar 110 bears on each cap 50b to fit it on the associated body 50a.

Although such a fitting-together system gives good results, it requires many moving parts such as racks, pinions, mechanical transmissions, etc. It is therefore desirable to find a simpler arrangement.

### DISCLOSURE OF THE INVENTION

One object of the present invention is to propose a fitting-together system that makes it possible to fit the cap on the body with a simplified mechanical system.

For this purpose, a system is proposed intended to fit a second piece on a first piece, said fitting-together system comprising:
a chassis,
a fitting-together bar intended to come into abutment against the second piece to move it and to fit it on the first piece and extending parallel to an actuation axis between two ends,
for each end, a first linkage and a second linkage, wherein each linkage has a proximal end and a distal end at which said end is mounted so as to be free to rotate about the actuation axis,
for the first two linkages, a first slider mounted so as to be able to translate on the chassis parallel to a translation direction and wherein the proximal ends of said first two linkages are mounted so as to be free to rotate about a first axis parallel to the actuation axis,
for the second two linkages, a second slider mounted so as to be able to translate with respect to the first slider parallel to the translation direction and wherein the proximal ends of said second two linkages are mounted so as to be free to rotate about a second axis parallel to the actuation axis,
for each slider, an actuator arranged to move said slider in translation, and
a control unit arranged to control each actuator.

Using simple translations facilitates the mechanism.

Advantageously, the fitting-together system comprises a midplane perpendicular to the actuation axis, on either side of which there is a first linkage and a second linkage.

Advantageously, the first two linkages are disposed outside the second two linkages.

According to a particular embodiment, the second slider is mounted so as to be able to translate on the chassis.

According to a particular embodiment, the second slider is mounted so as to be able to translate on the first slider.

Advantageously, for each proximal end, the associated slider comprises two bars between which said proximal end is mounted so as to be able to rotate.

The invention also proposes a moulding machine comprising moulding means for moulding a first piece and a second piece and a fitting-together system according to one of the preceding variants.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 is a perspective view of a fitting-together system of the prior art,

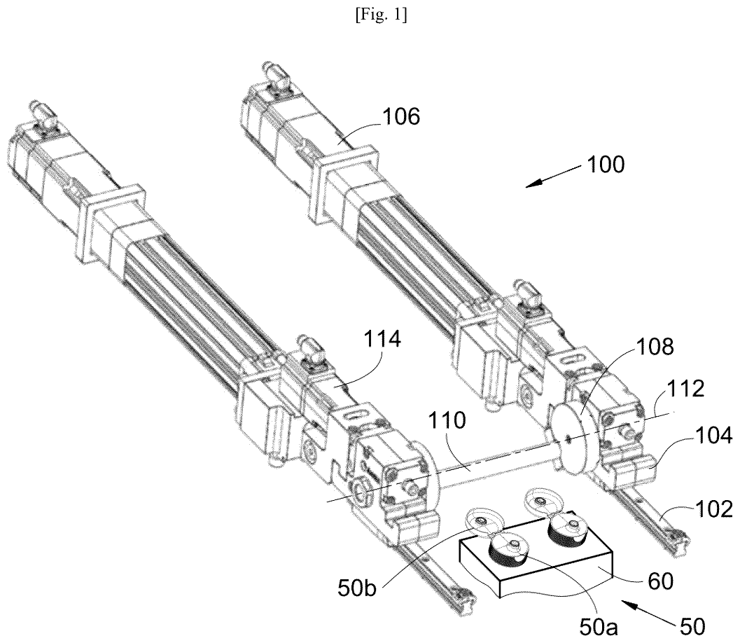

FIG. 2 is a perspective view of a fitting-together system according to a first embodiment of the invention.

FIG. 3 is a side view of the fitting-together system according to the invention, and

FIG. 4 is a perspective view of a fitting-together system according to a second embodiment of the invention.

### DETAILED DISCLOSURE OF EMBODIMENTS

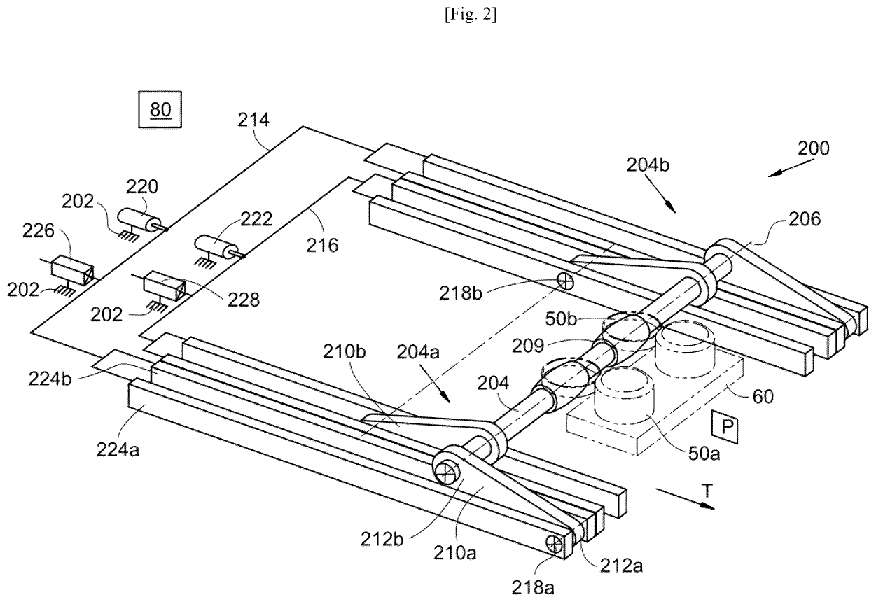

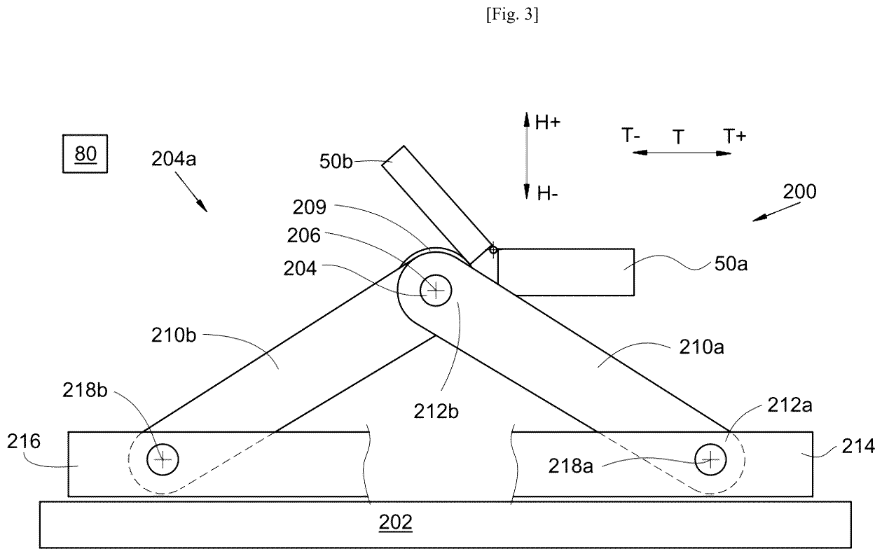

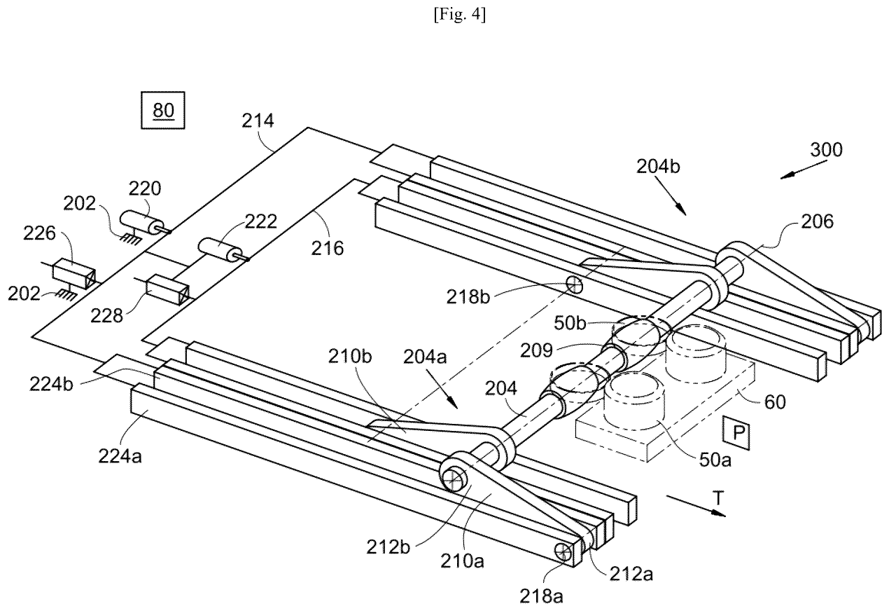

FIG. 2 shows a fitting-together system 200 according to a first embodiment of the invention, FIG. 4 shows a fitting-together system 300 according to a second embodiment of the invention, and FIG. 3 is a side view that applies to the two embodiments.

The fitting-together system 200, 300 can be implemented in a moulding machine that comprises moulding means such as jaws.

The moulding means conventionally comprise jaws (only one of which 60 is shown) that are conformed to implement the moulding of a first piece 50a and of a second piece 50b secured to each other by a hinge moulded at the same time as the pieces 50a and 50b. In the embodiment of the invention presented here, the first piece 50a is a body 50a of a closure 50 and the second piece 50b is a cap 50b of the same closure 50 hinged on the body 50a.

In general terms, the fitting-together system 200, 300 provides the rotational movement of the second piece 50b and the fitting of the latter on the first piece 50a and comprises a chassis 202 that may be an independent chassis or a part of the moulding machine.

The fitting-together system 200, 300 also comprises a fitting-together bar 204 that is arranged to come into abutment against the second piece 50b to move it and to fit it on the first piece 50a. As described below, the fitting-together bar 204 is first positioned under the first piece 50b, then pivots it about the hinge and finally passes above the second piece 50b to fit it on the first piece 50a.

The fitting-together bar 204 extends parallel to an actuation axis 206 between the two ends 204a-b thereof. In the embodiment of the invention presented here, the fitting-together bar 204 carries knobs 209 that are preferentially mounted so as to be able to rotate freely on the fitting-together bar 204 about the actuation axis 206 and the contact between the fitting-together bar 204 and the second piece 50b takes place through the knobs 209.

For each end 204a-b of the fitting-together bar 204, the fitting-together system 200, 300 comprises a first linkage 210a and a second linkage 210b. Each of these linkages 210a-b has a proximal end 212a and a distal end 212b at which the end 204a-b in question is mounted so as to be free to rotate about the actuation axis 206. Thus the fitting-together bar 204 is free to turn on itself with respect to the first linkages 210a.

For the first two linkages 210a, the fitting-together system 200, 300 comprises a first slider 214 that is mounted so as to be able to translate on the chassis 202. In FIGS. 2 to 4, the first slider 214 is shown schematically and can take all forms that can be envisaged by a person skilled in the art. The sliding connection between the chassis 202 and the first slider 214 is represented by the symbol referenced 226. The sliding connection can take all forms that can be envisaged by a person skilled in the art, such as for example the combination of grooves and ribs.

The proximal ends 212a of the first two linkages 210a are mounted so as to be able to rotate freely on the first slider 214 about one and the same first axis 218a parallel to the actuation axis 206.

In the same manner, for the second two linkages 210b, the fitting-together system 200, 300 comprises a second slider 216 that is mounted so as to be able to translate with respect to the first slider 214, i.e. the two sliders 214 and 216 move with respect to each other.

In the first embodiment of the invention, the second slider 216 is mounted so as to be able to move on the chassis 202, and in the second embodiment of the invention it is mounted so as to be able to move on the first slider 214.

The two sliders 214 and 216 are able to move in translation parallel to the same translation direction T, which is perpendicular to the actuation axis 206.

The second embodiment makes it possible to limit the length of movement parallel to the translation direction T.

As before, in FIGS. 2 to 4, the second slider 216 is shown schematically and can take all forms that can be envisaged by a person skilled in the art. The sliding connection between the second slider 216 and the chassis 202 or the first slider 214 is represented by the symbol referenced 228. The sliding connection can take all forms that can be envisaged by a person skilled in the art, such as for example the combination of grooves and ribs.

The proximal ends 212a of the second two linkages 210b are mounted so as to be able to rotate freely on the second slider 216 about one and the same second axis 218b parallel to the actuation axis 206.

The translation direction T corresponds to the direction of the sliding connections 226 and 228.

As shown in FIGS. 2 and 4, there is thus a first linkage 210a and a second linkage 210b to the left and one to the right with respect to the fitting-together bar 204.

For each slider 214, 216, the fitting-together system 200, 300 comprises an actuator 220, 222 arranged to move the corresponding slider 214, 216 in translation along the chassis 202 or along the first slider 214 in one direction or the other parallel to the translation direction T (T+/T−).

Each actuator 220, 222 is a linear actuator such as an electric, hydraulic or other cylinder.

The fitting-together system 200, 300 also comprises a control unit 80 arranged to control each actuator 220, 222. To provide a suitable movement of the fitting-together bar 204, the actuators 220 and 222 are controlled in a suitable manner so that the movements of the linkages 210a-b fulfil the required function.

The simple actuation of the actuators 220 and 222 on linear pathways makes it possible to move the fitting-together bar 204 to cause it to move the second piece 50b and to fit it on the first piece 50a. The mechanism used is therefore simpler than in the case of the prior art.

According to the relative movements between the first linkages 210a and the second linkages 210b, it is possible to make the fitting-together bar 204 adopt all the required positions. Thus, in FIG. 3, by bringing together the proximal ends 212a of the first 210a and second 210b linkages, the fitting-together bar 204 will rise H+and, conversely, by moving apart the proximal ends 212a of the first 210a second 210b linkages, the fitting-together bar 204 will lower H−. By moving the proximal ends 212a of the first 210a and second 210b linkages in one and the same direction T+/T−, the fitting-together bar 204 will move in the same direction. By combining these various movements, it is possible to give the fitting-together bar 204 all the possible movements.

Here, each slider 214, 216 has been considered as a single slider, but it is possible for each slider in fact to consist of two sub-sliders, namely one per pair of a first linkage 210a and a second linkage 210b and for each sub-slider to be controlled in translation by its own actuator, the two actuators moving together.

The linkages 210a-b are in planes perpendicular to the actuation axis 206.

For balancing reasons, the fitting-together system 200, 300 comprises a midplane P perpendicular to the actuation axis 206 and, on either side of this midplane P, there is a first linkage 210a and a second linkage 210b. That is to say, on one side of the midplane P, there is a first pair with a first linkage 210a and a second linkage 210b and, on the other side of the midplane P, there is a second pair with another first linkage 210a and another second linkage 210b. The pieces 50a-b to be fitted together are between these two pairs.

Here, the first two linkages 210a are disposed outside the second two linkages 210b.

In the embodiment of the invention shown in FIGS. 2 and 4, for each proximal end 212a, there are two bars 224a-b that are secured to the corresponding slider 214, 216. These two bars 224a-b are disposed parallel to each other and perpendicularly to the actuation axis 206. These two bars 224a-b are distant from each other and the associated proximal end 212a is disposed between these two bars 224a-b, and a rotation shaft corresponding to the associated axis 218a-b is also mounted between these two bars 224a-b. The proximal end 212a is mounted so as to be able to rotate on the rotation shaft between the associated bars 224a-b.

According to a particular embodiment, the control unit 80 comprises, connected by a communication bus: a processor or CPU (“Central Processing Unit”); a random access memory RAM; a read-only memory, for example a ROM or EEPROM (“Electrically Erasable Programmable ROM”), or of the flash type; a storage unit such as a hard disk drive HDD, or a storage medium reader, such as an SD (“Secure Digital”) card reader; and an interface manager I/f.

The interface manager I/f enables the control unit 80 to communicate with, among other things, the actuators.

The processor is capable of executing instructions loaded in the random access memory from the read-only memory, from an external memory, from a storage medium (such as an SD card), or from a communication network. When the hardware platform is powered up, the processor is capable of reading instructions from the random access memory and executing them. These instructions form a computer program causing the implementation, by the processor, of all or some of the steps and operations described here.

All or some of the steps and operations described here can thus be implemented in software form by executing a set of instructions by a programmable machine, for example a processor of the DSP (“digital signal processor”) type or a microcontroller, or be implemented in hardware form by a dedicated electronic machine or component (“chip”) or a set of dedicated electronic components (“chipset”), for example an FPGA (“field-programmable gate array”) or an ASIC (“application-specific integrated circuit”) component. In general terms, the control unit 80 comprises electronic circuitry adapted and configured to implement the operations and steps described here.

1. A fitting-together system intended to fit a second piece on a first piece, said fitting-together system comprising:
a chassis,
a fitting-together bar intended to come into abutment against the second piece to move it and to fit it on the first piece and extending parallel to an actuation axis between two ends,
for each end, a first linkage and a second linkage, wherein each linkage has a proximal end and a distal end at which said end is mounted so as to be free to rotate about the actuation axis,
for the first two linkages, a first slider mounted so as to be able to translate on the chassis parallel to a translation direction and wherein the proximal ends of said first two linkages are mounted so as to be free to rotate about a first axis parallel to the actuation axis,
for the second two linkages, a second slider mounted so as to be able to translate with respect to the first slider parallel to the translation direction and wherein the proximal ends of said second two linkages are mounted so as to be free to rotate about a second axis parallel to the actuation axis,
for each slider, an actuator arranged to move said slider in translation, and
a control unit arranged to control each actuator.

2. The fitting-together system according to claim 1, wherein it comprises a midplane (P) perpendicular to the actuation axis, on either side of which there is a first linkage and a second linkage.

3. The fitting-together system according to claim 2, wherein the first two linkages are disposed outside the second two linkages.

4. The fitting-together system according to claim 1, wherein the second slider is mounted so as to be able to translate on the chassis.

5. The fitting-together system according to claim 1, wherein the second slider is mounted so as to be able to translate on the first slider.

6. The fitting-together system according to claim 1, wherein, for each proximal end, the associated slider comprises two bars between which said proximal end is mounted so as to be able to rotate.

7. A moulding machine comprising moulding means for moulding a first piece and a second piece and a fitting-together system according to claim 1.
